(19) United States
(12) Patent Application Publication
(10) Pub. No.: US 2026/0221082 A1
(43) Pub. Date: Jul. 30, 2026

(54) Display Driver and Demultiplexer Circuitry for an Electronic Device

(71) Applicant: Apple Inc., Cupertino, CA (US)

(72) Inventors: Shin-Hung Yeh, Taipei (TW); Abbas Jamshidi Roudbari, Saratoga, CA (US); Chien-Ya Lee, Taipei (TW); I-Cheng Shih, Taoyuan (TW); Jianhong Lin, Taoyuan (TW); Cheng-Chih Hsieh, Santa Clara, CA (US); Tsung-Ting Tsai, San Jose, CA (US)

(21) Appl. No.: 19/384,560

(22) Filed: Nov. 10, 2025

Related U.S. Application Data
(60) Provisional application No. 63/751,163, filed on Jan. 29, 2025.

(51) Int. Cl. G09G 3/32

(52) U.S. Cl. CPC G09G 3/32; G09G 2300/0408; G09G 2300/0426; G09G 2310/0267; G09G 2310/0275; G09G 2310/0297

(57) ABSTRACT

An electronic device may have a display. The display may include an array of pixels in an active area of the display, a display driver circuit disposed towards a first peripheral edge of the active area and configured to output data signals, and demultiplexing circuitry disposed along a second peripheral edge of the active area. The demultiplexing circuitry is configured to demultiplex the data signals output from the display driver circuit into corresponding subpixel data signals for the array of pixels. The data signals may travel along respective pixel data lines in a first direction, whereas the subpixel data signals may travel along respective subpixel data lines in a second direction opposing the first direction. Each pixel in the array may include subpixel transistor structures and a transistor-free region through which a respective one of the pixel data lines can be routed.

This application claims the benefit of U.S. Provisional Patent Application No. 63/751,163, filed January 29, 2025, which is hereby incorporated by reference herein in its entirety.

### BACKGROUND

This relates generally to electronic devices, and, more particularly, to electronic devices with displays.

Electronic devices often include displays. For example, an electronic device may have an organic light-emitting diode (OLED) display based on organic light-emitting diode pixels or a liquid crystal display (LCD) based on liquid crystal display pixels. The display may include display driver circuitry that is configured to provide display data to the pixels and an associated data demultiplexer for demultiplexing the display data into subpixel data signals for respective subpixels of the pixels.

It is within this context that the embodiments herein arise.

### SUMMARY

An aspect of the disclosure provides a display that includes an array of pixels in an active area of the display, a display driver circuit disposed towards a first peripheral edge of the active area and configured to output data signals, and demultiplexing circuitry disposed along a second peripheral edge, different than the first peripheral edge, of the active area, where the demultiplexing circuitry is configured to demultiplex the data signals output from the display driver circuit into corresponding subpixel data signals for the array of pixels. The display can further include pixel data lines configured to convey the data signals from the display driver circuit to inputs of the demultiplexing circuitry in a first direction and subpixel data lines configured to convey the subpixel data signals from the demultiplexing circuitry to the array of pixels in a second direction opposite from the first direction.

The demultiplexing circuitry can include a plurality of demultiplexing units, where each demultiplexing unit in the plurality of demultiplexing units includes a first demultiplexing subunit coupled to first subpixel transistor structures in at least one pixel in the array via a first of the subpixel data lines, a second demultiplexing subunit coupled to second subpixel transistor structures in the at least one pixel via a second of the subpixel data lines, and a third demultiplexing subunit coupled to third subpixel transistor structures in the at least one pixel via a third of the subpixel data lines. Each demultiplexing unit in the plurality of demultiplexing units has a demultiplexer unit pitch, whereas the first subpixel transistor structures, the second subpixel transistor structures, and the third subpixel transistor structures of the at least one pixel can collectively have a pixel transistor pitch that is less than the demultiplexer unit pitch.

An aspect of the disclosure provides a display that includes a display pixel, a first data line traversing a portion of the display pixel and configured to convey data signals in a first direction, a demultiplexing unit having an input coupled to the first data line, and a plurality of subpixel data lines coupled to outputs of the demultiplexing unit and configured to convey subpixel data signals in a second direction, opposing the first direction, to the display pixel. The display can further include a display driver integrated circuit disposed along a first edge of the display, where the demultiplexing unit is disposed along a second edge, opposing the first edge, of the display. The portion of the display pixel traversed by the first data line can be a transistor-free region that is physically separate from red subpixel transistor structures, green subpixel transistor structures, and blue subpixel transistor structures of the display pixel. The demultiplexing unit can have a first pitch, whereas the red subpixel transistor structures, the green subpixel transistor structures, and the blue subpixel transistor structures can collectively have a second pitch that is less than the first pitch.

An aspect of the disclosure provides a display pixel that includes a first diode, first subpixel transistor structures associated with a first color and configured to output light of the first color using the first diode, a second diode, second subpixel transistor structures associated with a second color, different than the first color, and configured to output light of the second color using the second diode, a transistor-free region adjacent to the second subpixel transistor structures, and a data line routed through the transistor-free region. The display pixel can further include a third diode, and third subpixel transistor structures associated with a third color, different than the first and second colors, and configured to output light of the third color using the third diode, where the third subpixel transistor structures are interposed between the first subpixel transistor structures and the second subpixel transistor structures. The third diode has an anode region with a footprint that can overlap with the third subpixel transistor structures and extend at least partially into the transistor-free region.

### BRIEF DESCRIPTION OF THE DRAWINGS

FIG. 1 is a schematic diagram of an illustrative electronic device having a display in accordance with some embodiments.

FIG. 2 is a schematic diagram of an illustrative display in accordance with some embodiments.

FIG. 3 is a top (plan) view of an illustrative display having a driver circuit disposed at a first peripheral edge of the display and data demultiplexing circuitry disposed at a second (opposing) peripheral edge of the display in accordance with some embodiments.

FIG. 4 is a diagram showing how an illustrative display pixel can have a transistor pitch and how a demultiplexing unit can have a demultiplexer pitch that is different than the transistor pitch in accordance with some embodiments.

FIG. 5 is a top (plan) view of an illustrative display having data lines being routed in both vertical and horizontal directions, within an active area of the display, towards data demultiplexing circuitry in accordance with some embodiments.

FIG. 6 is a diagram showing how a display of the type shown in FIG. 5 can have a transistor pitch and a demultiplexer pitch that is different than the transistor pitch in accordance with some embodiments.

FIG. 7 is a top (plan) view of an illustrative display pixel having at least one diode element extending into a data line routing region of the pixel in accordance with some embodiments.

### DETAILED DESCRIPTION

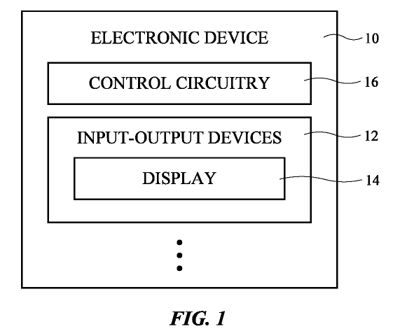

An illustrative electronic device of the type that may be provided with a display is shown in FIG. 1. Electronic device 10 may be a computing device such as a laptop computer, a computer monitor containing an embedded computer, a tablet computer, a cellular telephone, a media player, or other handheld or portable electronic device, a smaller device such as a wrist-watch device, a pendant device, a headphone or earpiece device, a device embedded in eyeglasses or other equipment worn on a user’s head, or other wearable or miniature device, a display, a computer display that contains an embedded computer, a computer display that does not contain an embedded computer, a gaming device, a navigation device, an embedded system such as a system in which electronic equipment with a display is mounted in a kiosk or automobile, or other electronic equipment. Electronic device 10 may have the shape of a pair of eyeglasses (e.g., supporting frames), may form a housing having a helmet shape, or may have other configurations to help in mounting and securing the components of one or more displays on the head or near the eye of a user.

As shown in FIG. 1, electronic device 10 may include control circuitry 16 for supporting the operation of device 10. Control circuitry 16 may include storage such as hard disk drive storage, nonvolatile memory (e.g., flash memory or other electrically-programmable-read-only memory configured to form a solid state drive), volatile memory (e.g., static or dynamic random-access memory), etc. Processing circuitry in control circuitry 16 may be used to control the operation of device 10. The processing circuitry may be based on one or more microprocessors, microcontrollers, digital signal processors, baseband processors, power management units, audio chips, application-specific integrated circuits, etc. Control circuitry 16 having both storage circuitry and processing circuitry is sometimes referred to collectively as storage and processing circuitry.

Input-output circuitry in device 10 such as input-output devices 12 may be used to allow data to be supplied to device 10 and to allow data to be provided from device 10 to external devices. Input-output devices 12 may include buttons, joysticks, scrolling wheels, touch pads, key pads, keyboards, microphones, speakers, tone generators, vibrators, cameras, sensors, light-emitting diodes and other status indicators, data ports, etc. A user can control the operation of device 10 by supplying commands through input resources of input-output devices 12 and may receive status information and other output from device 10 using the output resources of input-output devices 12.

Input-output devices 12 may include one or more displays such as display 14. Display 14 may be a touch screen display that includes a touch sensor for gathering touch input from a user or display 14 may be insensitive to touch. A touch sensor for display 14 may be based on an array of capacitive touch sensor electrodes, acoustic touch sensor structures, resistive touch components, force-based touch sensor structures, a light-based touch sensor, or other suitable touch sensor arrangements. A touch sensor for display 14 may be formed from electrodes formed on a common display substrate with the display pixels of display 14 or may be formed from a separate touch sensor panel that overlaps the pixels of display 14. If desired, display 14 may be insensitive to touch (i.e., the touch sensor may be omitted). Display 14 in electronic device 10 may be a head-up display that can be viewed without requiring users to look away from a typical viewpoint or may be a head-mounted display that is incorporated into a device that is worn on a user’s head. If desired, display 14 may also be a holographic display used to display holograms.

Control circuitry 16 may be used to run software on device 10 such as operating system code and applications. During operation of device 10, the software running on control circuitry 16 may display images on display 14.

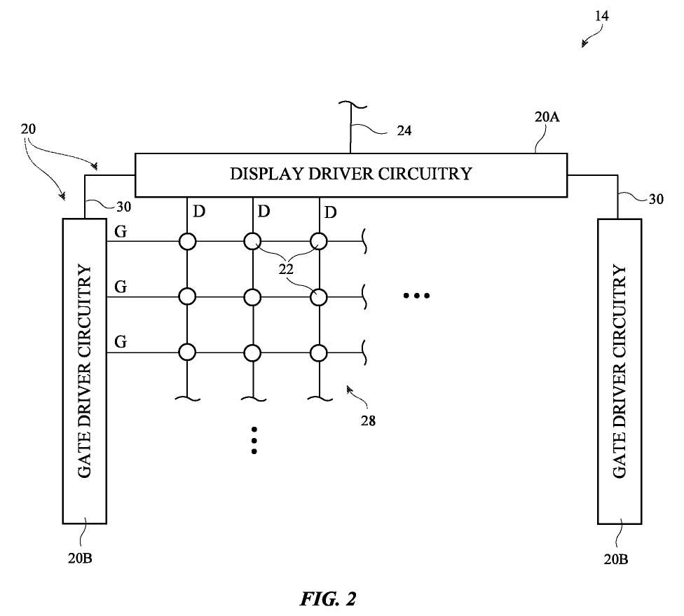

FIG. 2 is a diagram of an illustrative display 14. Display 14 may have an array of pixels 22 for displaying images for a user such as pixel array 28. Pixels 22 are sometimes referred to as display pixels. Display pixels 22 in array 28 may be arranged in rows and columns. The edges of array 28 may be straight or curved (i.e., each row of pixels 22 and/or each column of pixels 22 in array 28 may have the same length or may have a different length). There may be any suitable number of rows and columns in array 28 (e.g., ten or more, one hundred or more, or one thousand or more, etc.). Display 14 may include pixels 22 of different colors. As an example, display 14 may include red pixels, green pixels, and blue pixels. Pixels of other colors such as cyan, magenta, and yellow might also be used.

Display 14 may include display control circuitry 20 for controlling the operation of pixels 22. The display control circuitry 20 may be formed from integrated circuits, thin-film transistor circuits, and/or other suitable circuitry. Illustrative display control circuitry 20 of FIG. 2 can include display driver circuitry 20A and associated gate driver circuitry 20B. Gate driver circuitry 20B may be formed along one or more edges of display 14. For example, gate driver circuitry 20B may be arranged along the left and right sides of display 14 as shown in FIG. 2.

As shown in FIG. 2, display driver circuitry 20A, which can include one or more display driver integrated circuits, demultiplexing circuitry, and associated data line fanout routing lines, may further contain communications circuitry for communicating with system control circuitry (e.g., control circuitry 16 of FIG. 1) over signal path 24. Path 24 may be formed from traces on a flexible printed circuit or other cable. Control circuitry 16 may be located on one or more printed circuits (e.g., a main logic board) in electronic device 10. During operation, the control circuitry (e.g., control circuitry 16 of FIG. 1) may supply circuitry such as a display driver integrated circuit in display driver circuitry 20A with image data for images to be displayed on display 14. Display driver circuitry 20A is shown as being located towards the top peripheral edge of display 14 in the orientation of FIG. 2. This is merely illustrative. Display driver circuitry 20A may be located towards the bottom peripheral edge of display 14 or in other portions of device 10.

To display the images on pixels 22, display driver circuitry 20A may supply corresponding image data to data lines D while issuing control signals to supporting display control circuitry such as gate driver circuitry 20B over signal paths 30. With the illustrative arrangement of FIG. 2, data lines D run vertically through display 14 and are associated with respective columns of pixels 22.

Gate driver circuitry 20B, sometimes referred to as gate line driver circuitry or horizontal signal control circuitry, may be implemented using one or more integrated circuits and/or may be implemented using thin-film transistor circuitry. Horizontal control lines G (sometimes referred to as gate lines, scan lines, emission control lines, etc.) run horizontally across display 14. Each gate line G is associated with a respective row of display pixels 22. If desired, there may be multiple horizontal control lines such as gate lines G associated with each row of pixels. Individually controlled and/or global signal paths in display 14 may also be used to distribute other signals (e.g., power supply signals, etc.) across pixel array 28.

Gate driver circuitry 20B may assert control signals on the gate lines G in display 14. For example, gate driver circuitry 20B may receive clock signals and other control signals from display driver circuitry 20A on paths 30 and may, in response to the received signals, assert a gate line signal on gate lines G in sequence, starting with the gate line signal G in the first row of pixels 22 in array 28. As each gate line is asserted, data from data lines D may be loaded into a corresponding row of pixels. In this way, control circuitry such as display driver circuitry 20A and gate driver circuitry 20B may provide pixels 22 with signals that direct pixels 22 to display a desired image on display 14. Each pixel 22 may have a light-emitting diode and associated switching circuitry (e.g., thin-film circuitry on a substrate) that responds to the control and data signals from the display control circuitry 20.

Gate driver circuitry 20B may include blocks of gate driver circuitry such as gate driver row blocks. Each gate driver row block may include circuitry such output buffers and other output driver circuitry, register circuits (e.g., registers that can be chained together to form a shift register), and signal lines, power lines, and other interconnects. Each gate driver row block may supply one or more gate signals to one or more respective gate lines in a corresponding row of the pixels of the array of pixels in the active area of display 14.

Display driver circuitry such as display driver circuitry 20A can sometimes include a display driver integrated circuit for outputting data signals, demultiplexing circuitry for demultiplexing the data signals into corresponding subpixel data signals (e.g., red subpixel data signals, green subpixel data signals, blue subpixel data signals, etc.), and associated data routing lines for connecting the display driver integrated circuit to the demultiplexing circuitry. Conventional display configurations in which the display driver integrated circuit, data routing lines, and demultiplexing circuitry, all of which take up an insignificant amount of display substrate area, are all disposed along one peripheral edge of the display can impose a lower limit on how narrow the border can be for the overall display.

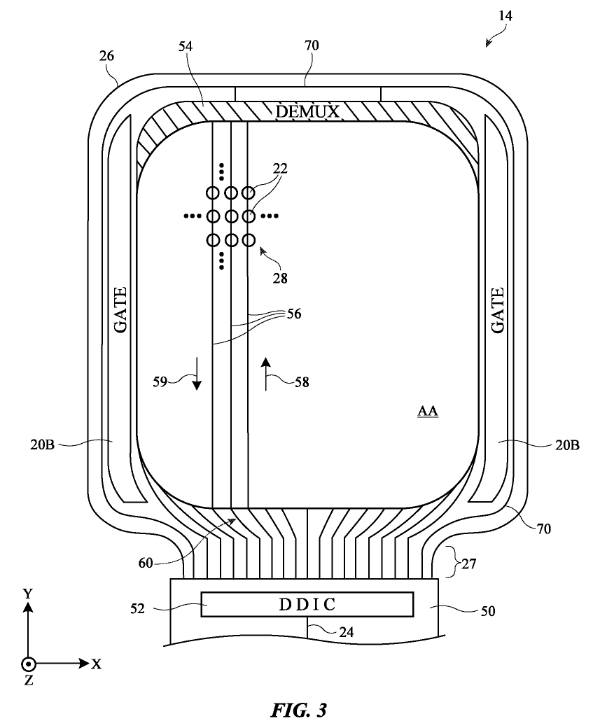

In accordance with an embodiment, display 14 of FIG. 3 is provided in which the display driver circuitry 20A is split up into multiple portions that are disposed along different edges of the display. As shown in the top (plan) view of FIG. 3, display 14 can include a display driver integrated circuit (DDIC) 52 disposed at a first (bottom) peripheral edge of display 14 and data demultiplexing circuitry 54 disposed along a second (top) peripheral edge of display 14. Display 14 may include layers such as substrate layer 26. Substrate layer 26 may be formed from rectangular planar layers of material or layers of material of other shapes (e.g., circular shapes or other shapes with one or more curved and/or straight edges). Substrate layer 26 may include glass layers, polymer layers, silicon layers, composite films that include polymer and inorganic materials, metallic foils, etc. Substrate layer 26 on which pixel array 28 is formed is sometimes referred to herein as a display panel. Substrate layer 26 is sometimes simply referred to herein as the display substrate.

Some of the display circuitry may be formed from thin-film circuits on a thin-film transistor layer or other layer in substrate layer 26. In the example of FIG. 3, gate driver circuitry 20B may be formed on the same thin-film transistor layer in which the display pixels 22 are formed. Other display circuitry may be formed from integrated circuits and may be mounted on a ledge portion of display 14, on a substrate adjacent to display 14, or may be mounted on a printed circuit substrate.

A flexible printed circuit cable such as flexible printed circuit 50 may be used to join display 14 and associated display circuitry with control circuitry 16. Components such as a display driver integrated circuit 52, a board-to-board connector, or other connectors may be mounted on flexible printed circuit cable 50. Display driver integrated circuit (DDIC) 52 may communicate directly with control circuitry 16 via signal path 24 to send control signals to gate driver circuitry 20B on either (left and right) edges of the display panel. The gate driver circuitry 20B disposed along the left peripheral edge of active area AA may include a chain of gate driver circuits configured to output row control signals for controlling a first portion of pixels 22 in active area AA. At the other end, gate driver circuitry 20B disposed along the right peripheral edge of active area AA may include a chain of gate driver circuits configured to output row control signals for controlling a second portion of pixels 22 in active area AA. Display driver integrated circuit 52 is also configured to output data signals onto corresponding data lines 56. Display driver integrated circuit 52 is sometimes referred to as a “timing controller” or a display driver circuit. In other words, control circuitry 16 can control display 14 through display driver integrated circuit 52 (e.g., control circuitry 16 is coupled to display 14 via timing controller 52).

Flexible printed circuit 50 may contain no rigid printed circuit board portions or may be a type of flexible printed circuit that is sometimes referred to as a “rigid flex” that has rigid printed circuit board portions combined with flexible portions. With one illustrative arrangement, the ends of flexible printed circuit 50 may be rigid printed circuit board portions (e.g., printed circuits formed from layers of rigid printed circuit board material such as fiberglass-filled epoxy) and the central portion of flexible printed circuit 50 may be formed from a length of flexible printed circuit that does not contain rigid portions (e.g., a flexible printed circuit formed form a flexible polymer substrate such as polyimide). Other types of flexible printed circuit may be used in forming a cable that extends between the display panel and control circuitry 16.

Display 14 may have an array of pixels 22. Pixels 22 are disposed in an active area AA of display 14 that displays images for a user. Active area AA is sometimes referred to as the active display area. The active area AA is surrounded by an inactive border area of display 14. The inactive border area runs along one or more of the edges of substrate 26 and do not contain pixels 22 and do not display images for the user (i.e., the display border is free or devoid of pixels 22). Gate driver circuitry 20B can be disposed along the left and right edges of the display substrate 26 (e.g., first gate driver circuitry 20B can be formed along the border region to the left of the active area AA, whereas second gate driver circuitry 20B can be formed along the border region to the right of the active area AA in the orientation of FIG. 3). In other suitable arrangements, gate driver circuitry 20B might be formed along only one edge of substrate 26.

As shown in the example of FIG. 3, display substrate 26 may have a tail portion such as tail portion 27 that has a narrower width than the portion of substrate 26 that contains active area AA. This arrangement helps accommodate tail potion 27 within the housing of device 10. Tail portion 27 may, if desired, be bent under the rest of display 14 when display 14 is mounted within the housing of device 10. Tail portion 27 can thus be formed from flexible substrate material. Flexible printed circuit 50 may be electrically coupled and attached to the tail portion 27 of the display substrate 26 (e.g., via conductive substrate bonding structures or other suitable connection means). The example of FIG. 3 in which display driver integrated circuit 52 is mounted on flexible printed circuit 50 is illustrative. In other embodiments, display driver integrated circuit 52 can be mounted on tail portion 27 or other portion of substrate 26.

Display 14 may include subpixels of different colors. As an example, each display pixel 22 of array 28 may include a red subpixel that emits red light, a green subpixel that emits green light, and a blue subpixel that emits blue light. The term “subpixel” can thus refer to and be defined herein as a portion of a pixel 22 configured to emit light of a particular color or range of wavelengths. Configurations for display 14 that include subpixels of other colors may be used, if desired. The use of a pixel arrangement with red, green, and blue subpixels is merely illustrative.

Display driver integrated circuit 52 may be configured to output data signals that contain grayscale information for multiple color channels such as red (R), green (G), and blue (B) channels. The data signals output from display driver integrated circuit 52 can be conveyed over data lines 56 that traverse active area AA in the direction of the Y axis. Display 14 may further include demultiplexing circuitry such as demultiplexing circuitry 54 configured to demultiplex the data signals into respective red, green, and blue “subpixel” data signals on respective “subpixel” data lines. Demultiplexing circuitry 54 is sometimes referred to as “demux” circuitry or a data line demultiplexer. The term “subpixel” when used to describe data signals or data lines can thus refer to data signals and data lines at the output of demultiplexing circuitry 54. Display driver integrated circuit 52, fanout region 60 (e.g., the data lines within fanout region 60), and demultiplexer circuitry 54 can all collectively be considered part of display driver circuitry 20A of FIG. 2.

As shown in FIG. 3, the data lines 56 traversing the active area AA can be coupled to display driver integrated circuit 52. Data lines 56 can be routed to display driver integrated circuit 52 via tail portion 27. The display active area AA may have a width that is greater than the width of tail portion 27. Due to this width differential, the data lines originating from display driver integrated circuit 52 may have a first routing line density closer to display driver integrated circuit 52 in the tail portion 27 and a second routing line density that is less than the first routing line density closer to active area AA. In other words, the data lines 56 coming out of tail portion 27 can spread or fan out to cover the wider width of active area AA, as shown by data line fanout region 60 (e.g., data lines 56 can curve or be routed at an angle in fanout portion 60). The data line fanout region 60 can take up a certain amount of substrate area.

To help minimize the inactive border area of display 14, demultiplexing circuitry 54 can be disposed along an edge of display active area AA that is different than the edge adjacent to data line fanout region 60. In the orientation of FIG. 3, data line fanout region 60 is disposed along the lower peripheral edge of substrate 26, whereas demultiplexing circuitry 54 is disposed along the upper (opposing) peripheral edge of substrate 26. This arrangement is merely illustrative. As another example, fanout region 60 can be disposed along the top edge of the display panel while demultiplexing circuitry 54 can be disposed along the bottom edge of the display panel. As another example, fanout region 60 can be disposed along the left edge of the display panel while demultiplexing circuitry 54 can be disposed along the right edge of the display panel. As yet another example, fanout region 60 can be disposed along the right edge of the display panel while demultiplexing circuitry 54 can be disposed along the left edge of the display panel.

In general, fanout region 60 can be disposed along a first peripheral edge of the display panel while demultiplexing circuitry 54 can be disposed along a second edge, opposing the first edge, of the display panel. If desired, fanout region 60 can be disposed along a first peripheral edge of the display panel while demultiplexing circuitry 54 can be disposed along a second edge, adjacent to the first edge, of the display panel. Placing the data line fanout region 60 and the demultiplexing circuitry 54 on different or opposing sides of the display panel helps minimize routing congestion along one peripheral edge of the display and is thus technically advantageous and beneficial to reduce the display inactive border area (i.e., to help achieve a narrower display border region).

Display driver integrated circuit 52 may be configured to output data signals onto corresponding data lines 56. The data signals on data lines 56 can be demultiplexed by demultiplexer circuitry 54 to produce corresponding “subpixel” data signals for controlling respective subpixels within respective columns of pixels 22. Demultiplexing circuitry 54 can include multiplexing switches that are selectively activated and deactivated using control signals output from display driver integrated circuit 52 and conveyed over control path 70. Control path (pathway) 70 for conveying the control signals from the display driver integrated circuit 52 to demultiplexing circuitry 54 can be referred to as a demultiplexer control path and may be routed along the outer peripheral edge of substrate 26. If desired, power supply lines (e.g., a positive power supply line and/or ground power supply line can be routed in a similar manner as demultiplexer control pathway 70, optionally at least partially overlapping with or adjacent to control pathway 70.

Since display driver integrated circuit 52 is disposed towards the bottom edge of the display panel while demultiplexing circuitry 54 is disposed towards the top edge of the display panel in the example of FIG. 3, the data signals output from display driver integrated circuit 52 will need to travel upwards in the direction of arrow 58 via data lines 56, traversing the entire display active area AA prior to being received at demultiplexing circuitry 54. Data lines 56 carrying signals prior to being processed by demultiplexing circuitry 54 can sometimes be referred to as “pixel” or “pre-demultiplexer” data lines. Each pixel (pre-demultiplexer) data line 56 can thus have a first distal end coupled to the data line fanout region 60 and a second distal end coupled to an input of demultiplexer circuitry 54.

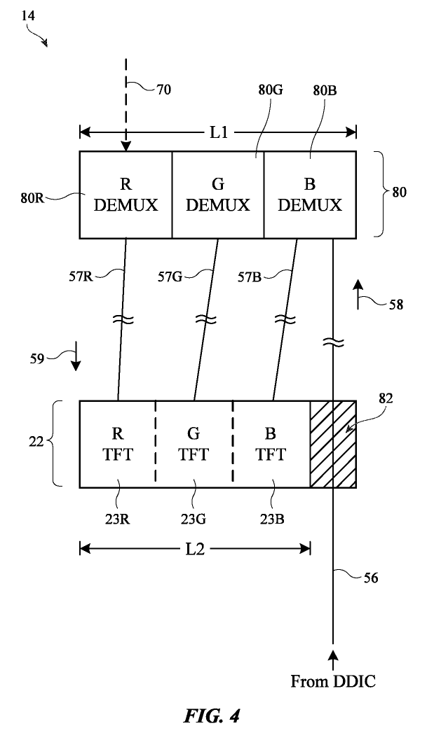

Demultiplexer circuitry 54 can receive the data signals conveyed through pixel data lines 56 and output corresponding demultiplexed data signals back down towards the subpixels of pixels 22 in the direction of arrow 59, which is opposite to the direction of arrow 58. The demultiplexed data signals output from demultiplexer circuitry 54 can sometimes be referred to and defined herein as “subpixel” data signals (e.g., red subpixel data signals, green subpixel data signals, blue subpixel data signals, etc.). Details of how the pixel data signals and the subpixel data signals can be conveyed to corresponding subpixels in each pixel 22 are described in more detail below in connection with FIG. 4.

FIG. 4 is a diagram showing how data signals can be routed to a display pixel 22 within the display active area. FIG. 4 shows a demultiplexing unit such as demultiplexing unit 80. Demultiplexing circuitry 54 can include multiple demultiplexing units 80 arranged along an edge of the display active area (see, e.g., FIG. 3 where demultiplexing circuitry 54 is disposed along the top edge of active area AA). Demultiplexing unit 80 can include a red (R) subpixel demultiplexing subunit 80R, a green (G) subpixel demultiplexing subunit 80G, and a blue (B) subpixel demultiplexing subunit 80B. Each of demultiplexing subunits 80R, 80G, and 80B can include one or more multiplexer switches selectively activated based on control signals conveyed through control path 70 to pass through data signals from an associated data line 56. Demultiplexing subunits 80R, 80G, and 80B can collectively have a total demultiplexer unit pitch L1. Demultiplexer unit pitch L1 can sometimes be referred to herein as a pixel column width.

Pixel 22 can include thin film transistor (TFT) structures associated with various subpixels such as red (R) subpixel TFT structures 23R, green (G) subpixel TFT structures 23G, and blue (B) subpixel TFT structures 23B. The red subpixel TFT structures 23R can be configured to receive red subpixel data signals from demultiplexing subunit 80R via subpixel data line 57R. Subpixel data line 57R can be coupled to an output of demultiplexing subunit 80R. The green subpixel TFT structures 23G can be configured to receive green subpixel data signals from demultiplexing subunit 80G via subpixel data line 57G. Subpixel data line 57G can be coupled to an output of demultiplexing subunit 80G. The blue subpixel TFT structures 23B can be configured to receive blue subpixel data signals from demultiplexing subunit 80B via subpixel data line 57B. Subpixel data line 57B can be coupled to an output of demultiplexing subunit 80B. These subpixel TFT structures can collectively have a total pixel transistor pitch L2 that is less than the demultiplexer unit pitch L1 in accordance with some embodiments.

By designing pixel 22 with a pixel transistor pitch L2 being less than the pixel column width (pitch) L1, data line 56 can be routed through a TFT-free region 82 along an edge of pixel 22. Region 82 may be devoid of subpixel transistor structures. TFT-free region 82 can thus sometimes be referred to herein as a data line routing region or a transistor-free region. Transistor-free region 82 is physically separate from the red subpixel transistor structures 23R, the green subpixel transistor structures 23G, and the blue subpixel transistor structures 23B. Arranged in this manner, the pixel data signals output from display driver integrated circuit 52 can travel in the direction of arrow 58 across the active area towards demultiplexing unit 80. Demultiplexing unit 80 can then demultiplex the pixel data signals and then successively output corresponding red subpixel data signals to the red subpixel structures 23R via subpixel data line 57R, green subpixel data signals to the green subpixel structures 23G via subpixel data line 57G, and blue subpixel data signals to the blue subpixel structures 23G via subpixel data line 57B in the direction of arrow 59.

The example of FIG. 4 in which TFT-free region 82 through which pixel data line 56 can be routed is disposed at the rightmost edge of pixel 22 is illustrative. As another example, the TFT-free region 82 can be disposed at the leftmost edge of pixel 22, and data line 82 can traverse that portion of pixel 22. As another example, the TFT-free region 82 can be disposed between the red subpixel TFT structures 23R and the green subpixel TFT structures 23G, and data line 56 can traverse that portion of pixel 22. As another example, the TFT-free region 82 can be disposed between the green subpixel TFT structures 23G and the blue subpixel TFT structures 23B, and data line 56 can traverse that portion of pixel 22. As another example, the TFT-free region 82 can be disposed between the red subpixel TFT structures 23R and the blue subpixel TFT structures 23B, and data line 56 can traverse that portion of pixel 22. In general, TFT-free region 82 can be disposed at any portion of pixel 22.

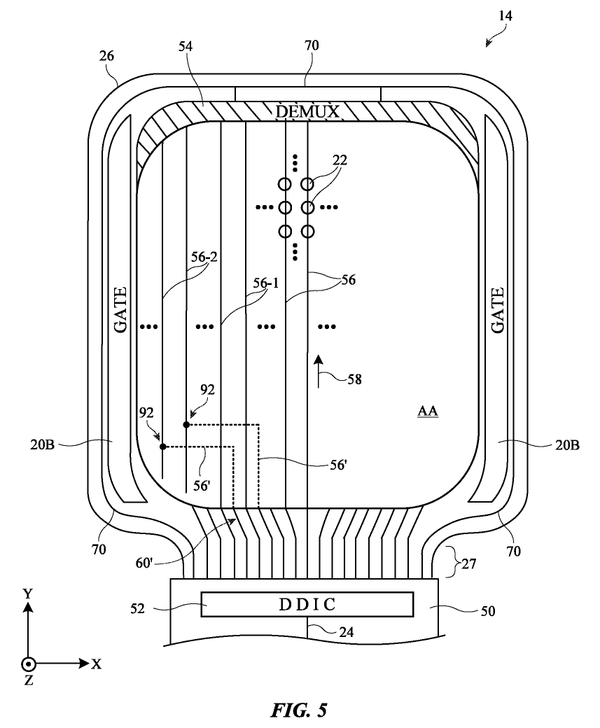

The embodiment of FIG. 3 in which the data line fanout region 60 is outside the display active area AA is exemplary. FIG. 5 shows another embodiment of display 14 in which the pixel data lines fan out within the active area AA. As shown in FIG. 5, a first portion of the data lines such as data lines 56 traversing active area AA are coupled to straight lines in fanout region 60’ (e.g., vertical data lines being routed in parallel to the Y axis), whereas a second portion of the data lines such as data lines 56-1 traversing active area AA are coupled to curved or slanted data lines in fanout region 60’ (e.g., data lines being routed at an angle that is not parallel to the Y axis).

In accordance with some embodiments, a third portion of the data lines such as data lines 56-2 traversing active area AA can be coupled to data lines in fanout region 60’ via routing lines 56’ within active area AA. Data lines 56, 56-1, and 56-2 can all be configured to route data signals from display driver integrated circuit 52 towards demultiplexing circuitry 54 in the direction of arrow 58. In particular, routing lines 56’ can have first segments being routed in the vertical direction (e.g., in a direction parallel with the Y axis) and second segments being routed in the horizontal direction (e.g., in a direction parallel with the X axis) within active area AA. The first segments of routing lines 56’ are thus sometimes referred to as vertical segments, whereas the second segments of routing lines 56’ are sometimes referred to as horizontal segments.

The first (vertical or column-wise) segments of routing lines 56’ can run parallel with data lines 56, 56-1, and 56-2, whereas the second (horizontal or row-wise) segments of routing lines 56’ can run orthogonal to data lines 56, 56-1, and 56-2. The second segments of routing lines 56’ can be formed in a different conductive routing layer than data lines 56, 56-1, and 56-2 (e.g., the horizontal segments can be formed in a metal routing layer above or below the vertical data lines when viewed from a cross-sectional side view of the display stack). The routing lines 56’ can be electrically coupled to data lines 56-2 using one or more conductive vias 92. The conductive vias 92 are configured to connect data lines 56-2 in a first conductive routing layer to the horizontal segments of lines 56’ formed in a second conductive routing layer above or below the first conductive routing layer.

The use of routing lines 56’ within the active area AA for connecting the data lines in fanout region 60’ to data lines 56-2 that extend beyond the width of the tail portion 27 can be technically advantageous and beneficial to reduce the need to spread (fan) out the data lines in the fanout region and can thus reduce the area that is needed for fanout region 60’. Routing lines 56’ for connecting the data lines in region 60’ to data lines 56-2 towards the outer portions of active area AA that are more difficult to reach can also sometimes be referred to and defined herein as “in-active-area fanout” routing lines. Connected in this way, fanout region 60’ of FIG. 5 can have a relatively smaller area relative to fanout region 60 of FIG. 3. Display 14 of FIG. 5 can thus exhibit an even smaller inactive border area compared to display 14 of FIG. 3. The remaining structures of display 14 in FIG. 5 are similar to that already described in connection with FIG. 3 and need not be reiterated here to avoid obscuring the present embodiment.

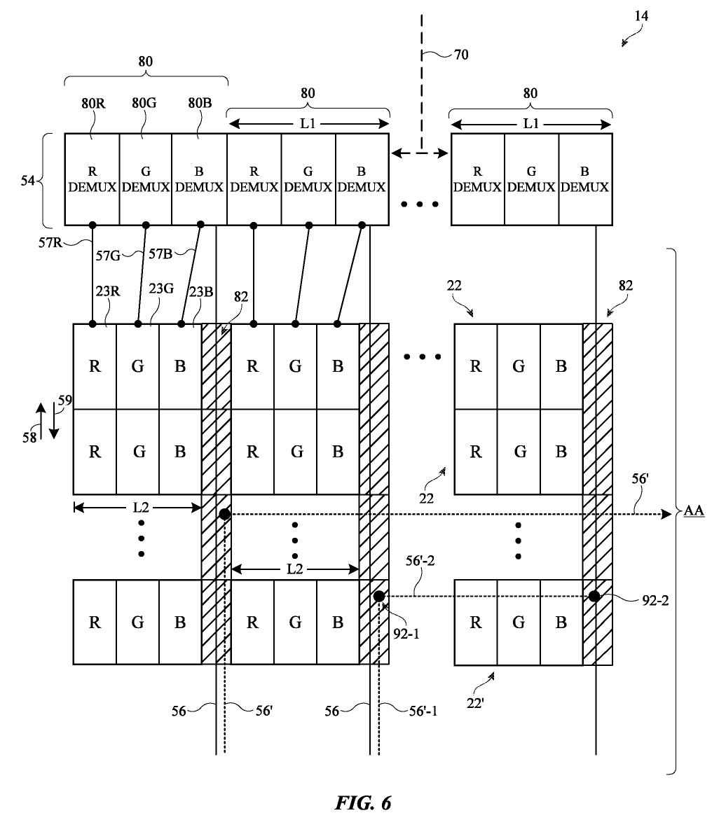

FIG. 6 is a diagram showing how data signals can be routed to a display pixel 22 within the display active area of display 14 of the type described in connection with FIG. 5. FIG. 6 shows how demultiplexing circuitry 54 can include multiple demultiplexing units 80 arranged in a row (see, e.g., FIG. 3 where demultiplexing circuitry 54 is disposed along the top edge of active area AA). Each demultiplexing unit 80 can include a red (R) subpixel demultiplexing subunit 80R, a green (G) subpixel demultiplexing subunit 80G, and a blue (B) subpixel demultiplexing subunit 80B. Each of demultiplexing subunits 80R, 80G, and 80B can include one or more multiplexer switches selectively activated based on control signals conveyed through control path 70 to pass through data signals from an associated pixel data line 56. Demultiplexing unit 80 can have a demultiplexer unit pitch L1. Demultiplexer unit pitch L1 can sometimes be referred to herein as a pixel column width.

Each display pixel 22 can include thin film transistor (TFT) structures associated with various subpixels such as red (R) subpixel TFT structures 23R, green (G) subpixel TFT structures 23G, and blue (B) subpixel TFT structures 23B. The red subpixel TFT structures 23R can be configured to receive red subpixel data signals from demultiplexing subunit 80R via subpixel data line 57R. The green subpixel TFT structures 23G can be configured to receive green subpixel data signals from demultiplexing subunit 80G via subpixel data line 57G. The blue subpixel TFT structures 23B can be configured to receive blue subpixel data signals from demultiplexing subunit 80B via subpixel data line 57B. These subpixel TFT structures can collectively have a total transistor (TFT) pitch L2 that is less than the demultiplexer unit pitch L1 in accordance with some embodiments.

By designing pixel 22 with a transistor pitch L2 that is less than the demultiplexer unit pitch L1, data line 56 can be routed through TFT-free region 82 along an edge of pixel 22. Region 82 may be devoid of subpixel transistor structures. Regions 82 of pixels 22 arranged along a given pixel column can form a continuous vertical strip that is devoid of TFT structures. Arranged in this manner, the pixel data signals output from display driver integrated circuit 52 can travel in the direction of arrow 58 across the active area towards demultiplexing circuitry 54. Demultiplexing circuitry 54 can then demultiplex the pixel data signals and successively output corresponding red subpixel data signals to the red subpixel structures 23R via subpixel data line 57R, green subpixel data signals to the green subpixel structures 23G via subpixel data line 57G, and blue subpixel data signals to the blue subpixel structures 23G via subpixel data line 57B in the direction of arrow 59.

FIG. 6 further shows how the in-active-area fanout routing lines 56’ can also be routed through TFT-free regions 82. In particular, the vertical segments of routing lines 56’ can traverse one or more TFT-free regions 82 (see, e.g., vertical segment 56’-1 extending at least partially into a TFT-free region 82). The vertical segment 56’-1 can optionally be coupled to a corresponding horizontal segment 56’-2 via one or more conductive vias 92-1. In other words, vertical segment 56’-1 can be formed in one conductive routing layer within the display stack while horizontal segment 56’-2 can be formed in another (different) conductive routing layer within the display stack.

Horizontal segment 56’-2 can be coupled to a vertical (straight or linear) data line 56 through one or more conductive vias 92-2. Horizontal segment 56’-2 can be routed over (traversing) one or more intervening pixels such as pixel 22’. Horizontal segment 56’-2 of routing line 56’ and data line 56 can be formed in different conductive (metal) routing layers of the display stack. Connected in this way, the corresponding fanout region 60’ of FIG. 5 can have a relatively smaller area relative to fanout region 60 of FIG. 3. Display 14 of FIG. 6 can thus exhibit an even smaller inactive border area compared to display 14 of FIG. 3.

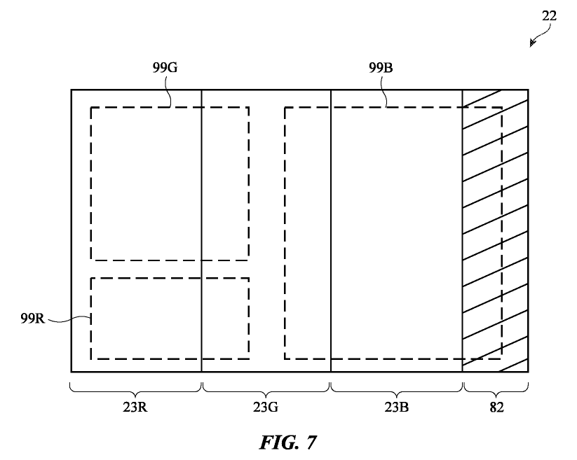

FIG. 7 is a top (plan) view of an illustrative display pixel 22 of the type described in connection with FIGS. 1-6. Pixel 22 can include red subpixel transistor structures 23R, green subpixel transistor structures 23G, blue subpixel transistor structure 23B, and a transistor-free region 82 through which a pixel data line 56, a vertical segment of an in-active-area fanout routing lines 56’, a subpixel data line (e.g., lines 57R, 57G, and/or 57B), and/or other column lines can be routed. Pixel 22 can further include subpixel light-emitting diodes such as a red light-emitting diode 99R (e.g., a diode having an anode region configured to emit red light), a green light-emitting diode 99R (e.g., a diode having an anode region configured to emit green light), and a blue light-emitting diode 99B (e.g., a diode having an anode region configured to emit blue light).

In accordance with an embodiment, the various diodes within pixel 22 need not be spatially aligned to the different subpixel TFT regions. In the example of FIG. 7, diode 99G can overlap with transistor structures 23R and 23G (e.g., diode 99G can have a footprint formed above a portion of structures 23R and a portion of structures 23G); diode 99R can overlap with transistor structures 23R and 23G (e.g., diode 99R can have a footprint formed above a portion of structures 23R and a portion of structures 23G); and diode 99B can overlap with transistor structures 23G, 23B, and TFT-free region 82 (e.g., diode 99B can have a footprint formed above a portion of structures 23G, structures 23B, and region 82). In other words, diode 99B can extend into TFT-free region 82.

The diode arrangement of FIG. 7 is merely exemplary. In general, pixel 22 can include any number of diodes each of which has a footprint that is disposed over or overlaps one or more portions of the various subpixel TFT structures within pixel 22. One or more diodes can extend into TFT-free region 82, as shown in FIG. 7. Alternatively, none of the diodes may overlap with TFT-free region 82. In such arrangements, region 82 can also be referred to as a diode-free region (e.g., region 82 may be devoid of an overlapping light-emitting anode region).

The foregoing is merely illustrative and various modifications can be made by those skilled in the art without departing from the scope and spirit of the described embodiments. The foregoing embodiments may be implemented individually or in any combination.

What is claimed is:

1. A display comprising:
an array of pixels in an active area of the display;
a display driver circuit disposed towards a first peripheral edge of the active area and configured to output data signals; and
demultiplexing circuitry disposed along a second peripheral edge, different than the first peripheral edge, of the active area, wherein the demultiplexing circuitry is configured to demultiplex the data signals output from the display driver circuit into corresponding subpixel data signals for the array of pixels.

2. The display of claim 1, further comprising:
a first plurality of gate driver circuits disposed along a third peripheral edge, different than the first and second peripheral edges, of the active area.

3. The display of claim 2, further comprising:
a second plurality of gate driver circuits disposed along a fourth peripheral edge, opposing the third peripheral edge, of the active area.

4. The display of claim 1, wherein the first and second peripheral edges comprise opposing edges of the active area.

5. The display of claim 1, further comprising:
pixel data lines configured to convey the data signals from the display driver circuit to inputs of the demultiplexing circuitry in a first direction; and
subpixel data lines configured to convey the subpixel data signals from the demultiplexing circuitry to the array of pixels in a second direction opposite from the first direction.

6. The display of claim 5, wherein the demultiplexing circuitry comprises:
a plurality of demultiplexing units, wherein each demultiplexing unit in the plurality of demultiplexing units includes:
a first demultiplexing subunit coupled to first subpixel transistor structures in at least one pixel in the array via a first of the subpixel data lines;
a second demultiplexing subunit coupled to second subpixel transistor structures in the at least one pixel via a second of the subpixel data lines; and
a third demultiplexing subunit coupled to third subpixel transistor structures in the at least one pixel via a third of the subpixel data lines.

7. The display of claim 6, wherein:
each demultiplexing unit in the plurality of demultiplexing units has a demultiplexer unit pitch; and
the first subpixel transistor structures, the second subpixel transistor structures, and the third subpixel transistor structures of the at least one pixel collectively have a pixel transistor pitch that is less than the demultiplexer unit pitch.

8. The display of claim 5, wherein each pixel in the array comprises a transistor-free region through which a respective one of the pixel data lines is routed.

9. The display of claim 5, wherein at least some of the pixel data lines are coupled to fanout routing lines, and wherein at least one of the fanout routing lines comprises:
a first routing segment that runs parallel to the pixel data lines; and
a second routing segment that runs orthogonal to the first routing segment, wherein the second routing segment traverses one or more pixels in the active area.

10. The display of claim 1, wherein data lines in a fanout region that is interposed between the active area and the display driver circuit comprise straight data lines and data lines being routed at an angle that is not parallel to the straight data lines.

11. The display of claim 1, further comprising:
a substrate on which the array of pixels are disposed; and
a flexible printed circuit, different than the substrate, on which the display driver circuit is disposed, wherein the flexible printed circuit is electrically coupled to a tail portion of the substrate.

12. The display of claim 11, further comprising:
a conductive path routed along a peripheral edge of the substrate and configured to convey control signals output from the display driver circuit to the demultiplexer circuitry.

13. A display comprising:
a display pixel;
a first data line traversing a portion of the display pixel and configured to convey data signals in a first direction;
a demultiplexing unit having an input coupled to the first data line; and
a plurality of subpixel data lines coupled to outputs of the demultiplexing unit and configured to convey subpixel data signals in a second direction, opposing the first direction, to the display pixel.

14. The display of claim 13, further comprising:
a display driver integrated circuit disposed along a first edge of the display, wherein the demultiplexing unit is disposed along a second edge, opposing the first edge, of the display.

15. The display of claim 13, wherein the display pixel comprises:
red subpixel transistor structures coupled to a first subpixel data line in the plurality of subpixel data lines;
green subpixel transistor structures coupled to a second subpixel data line in the plurality of subpixel data lines; and
blue subpixel transistor structures coupled to a third subpixel data line in the plurality of subpixel data lines.

16. The display of claim 15, wherein the portion of the display pixel traversed by the first data line comprises a transistor-free region that is physically separate from the red subpixel transistor structures, the green subpixel transistor structures, and the blue subpixel transistor structures.

17. The display of claim 15, wherein the demultiplexing unit has a first pitch and wherein the red subpixel transistor structures, the green subpixel transistor structures, and the blue subpixel transistor structures collectively have a second pitch that is less than the first pitch.

18. A display pixel comprising:
a first diode;
first subpixel transistor structures associated with a first color and configured to output light of the first color using the first diode;
a second diode;
second subpixel transistor structures associated with a second color, different than the first color, and configured to output light of the second color using the second diode;
a transistor-free region adjacent to the second subpixel transistor structures; and
a data line routed through the transistor-free region.

19. The display pixel of claim 18, further comprising:
a third diode; and
third subpixel transistor structures associated with a third color, different than the first and second colors, and configured to output light of the third color using the third diode, wherein the third subpixel transistor structures are interposed between the first subpixel transistor structures and the second subpixel transistor structures.

20. The display pixel of claim 19, wherein the third diode has an anode region with a footprint that overlaps with the third subpixel transistor structures and extends at least partially into the transistor-free region.
